(19) United States
(12) Patent Application Publication
(10) Pub. No.: US 2015/0227950 A1
(43) Pub. Date: Aug. 13, 2015

(54) SYSTEMS AND METHODS FOR ASCERTAINING NETWORK MARKET SUBSCRIPTION COVERAGE

(71) Applicant: Rentrak Corporation, Portland, OR (US)

(72) Inventors: Michael Vinson, Piedmont, CA (US); Maria Loper, Portland, OR (US); Aaron Harsh, Portland, OR (US); Bruce Goerlich, Forest Hills, NY (US); Amir Yazdani, Portland, OR (US); Jia Liu, Portland, OR (US)

(21) Appl. No.: 14/622,694

(22) Filed: Feb. 13, 2015

Related U.S. Application Data
(60) Provisional application No. 61/939,503, filed on Feb. 13, 2014.

(51) Int. Cl. G06Q 30/02

(52) U.S. Cl. CPC G06Q 30/0201

(57) ABSTRACT

A system and methods for estimating network subscription coverage within or across various markets. The system generates estimates of viewers that subscribe to certain network subscription packages in various geographic markets. The estimates may be organized in different fashions, such as organized by households, by income or other demographic, etc. In some embodiments, the system iteratively scales an estimated viewership count in a given market based on existing subscription data across all the markets and demographic characteristics of the various markets. The system may also redistribute estimates based on market capacity.

### CROSS-REFERENCE TO RELATED APPLICATIONS

This application claims priority and is a nonprovisional of U.S. Provisional. Pat. App. No. 61/939,503 filed on Feb. 13, 2014 the contents of which are incorporated herein in their entirety for all purposes.

### BACKGROUND

In the US and many foreign markets, content producers, distributors and advertisers have many different channels through which to distribute content and advertising. For example, content and advertising may be distributed through satellite networks, cable networks, broadcast networks, broadband networks (including, e.g., Internet streaming and Over-the-Top Viewing), etc., to subscribers. To judge the effectiveness of content and advertising, interested parties often want to understand how broadly and how effectively, their product is reaching various markets. Unfortunately, many network operators do not release subscriber package information for individual markets. As a result, any parties seeking to understand the extent of content or advertising distribution have an incomplete picture of the network viewership. The incomplete data makes it difficult for content producers, distributors, advertisers, or other interested parties to make accurate decisions about distribution channels.

### BRIEF DESCRIPTION OF THE DRAWINGS

One or more embodiments of the present disclosure are illustrated by way of example and not limitation in the figures of the accompanying drawings, in which like reference numerals indicate identical or functionally similar elements:

FIG. 1 illustrates a data collection and processing topology for a plurality of households in different geographic markets as may occur in some embodiments;

FIG. 2 illustrates a high-level topology of the strata data as can be used to make a subscription market allocation determination as may occur in some embodiments;

FIG. 3 illustrates a high-level topology of a data processing architecture to determine a per-market distribution of network viewership as may occur in some embodiments;

FIG. 4 is a flow diagram depicting various steps in a subscription market allocation process as may occur in some embodiments;

FIG. 5 illustrates a market allocation of subscription counts following a first iteration of allocations as may occur in some embodiments;

FIG. 6 illustrates a market allocation of subscription counts following a second or subsequent iteration of allocations;

FIG. 7 is a high level block diagram illustrating steps in an example subscription calculation as may be performed in some embodiments;

FIG. 8 is a flow diagram illustrating aspects of the example subscription calculation of FIG. 7 in greater detail;

FIG. 9 is an example network package data matrix as may be implemented in some embodiments;

FIG. 10 is a collection of example network coverage data matrices as may be implemented in some embodiments;

FIG. 11 is an example household network data matrix as may be implemented in some embodiments;

FIG. 12 is a flow diagram depicting operations applied to a household matrix as may occur in some embodiments;

FIG. 13 is an example hypothetical market household breakdown as may be presented in some embodiments;

FIG. 14 shows a diagrammatic representation of a machine in the example form of a computer system within which a set of instructions for causing the machine to perform any one or more of the methodologies discussed herein can be executed.

While the flow and sequence diagrams presented herein show an organization designed to make them more comprehensible by a human reader, those skilled in the art will appreciate that actual data structures used to store this information may differ from what is shown, in that they, for example, may be organized in a different manner; may contain more or less information than shown; may be compressed and/or encrypted; etc.

The headings provided herein are for convenience only and do not necessarily affect the scope or meaning of the claimed embodiments. Further, the drawings have not necessarily been drawn to scale. For example, the dimensions of some of the elements in the figures may be expanded or reduced to help improve the understanding of the embodiments. Similarly, some components and/or operations may be separated into different blocks or combined into a single block for the purposes of discussion of some of the embodiments. Moreover, while the various embodiments are amenable to various modifications and alternative forms, specific embodiments have been shown by way of example in the drawings and are described in detail below. The intention, however, is not to limit the particular embodiments described. On the contrary, the embodiments are intended to cover all modifications, equivalents, and alternatives falling within the scope of the disclosed embodiments as defined by the appended claims.

### DETAILED DESCRIPTION

Systems and methods for estimating network subscription coverage within or across various markets are disclosed herein. In some embodiments, a system generates estimates of viewers that subscribe to certain network subscription packages in various geographic markets. The estimates may be organized in different fashions, such as organized by households, by income or other demographic, etc. and may apply to different content media, including, e.g., television and Internet streaming through broadband networks. In some embodiments, the system iteratively scales an estimated viewership count in a given market based on existing subscription data across all the markets and demographic characteristics of the various markets. The system may also redistribute estimates based upon market capacity. By generating more accurate network subscription data, the system facilitates better planning and spending by content producers, distributors, advertisers, and other interested parties.

The following description and drawings are illustrative and are not to be construed as limiting. Numerous specific details are described to provide a thorough understanding of the variously disclosed concepts.

### Example Topology Overview

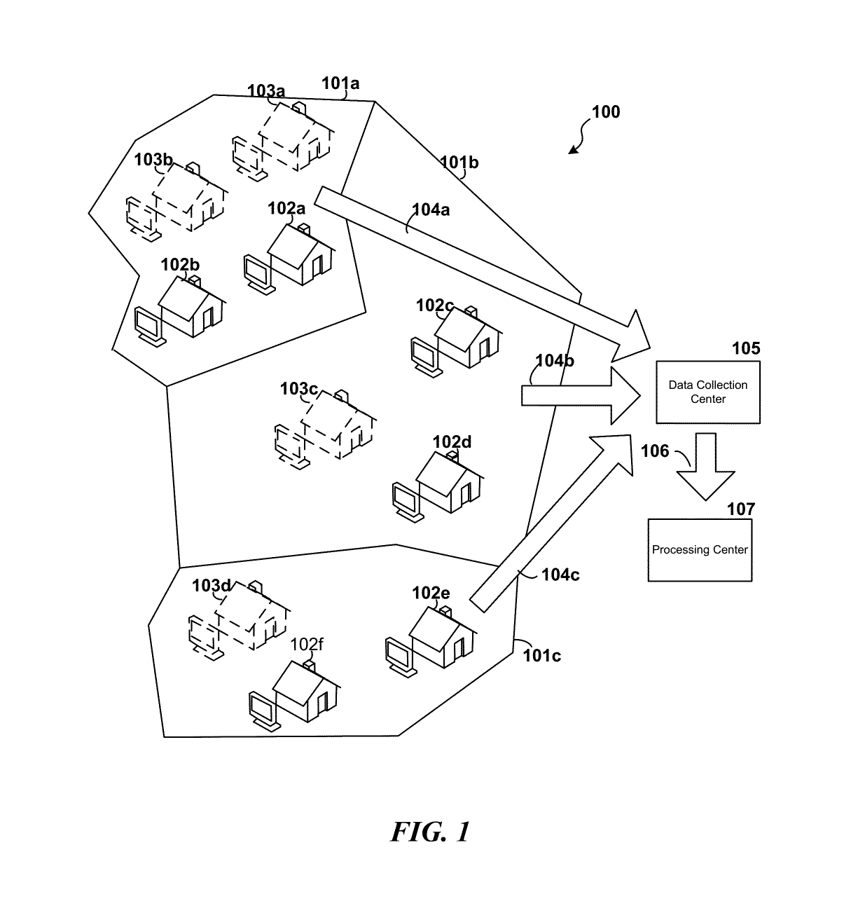

FIG. 1 illustrates a television viewing data collection and processing topology 100 for a plurality of households in different geographic markets as can be implemented in some embodiments. Several geographic markets 101a-c each contain a plurality of households 102a-f and 103a-d. Individual, per-market data can be available for some households 102a-f but not for others 103a-d (e.g., either because the households 103a-d do not report their data, or are not yet scheduled to report their data). The “reporting” households are households that send television viewing data 104a-c to one or more data collection centers 105. Television viewing data 104a-c can include, e.g., channel change information, set top box power and activity status information, scheduled recording periods for a home recording device, etc. The one or more data collection centers 105 can then provide some or all television viewing data 104a-c as received data 106 to a processing center 107.

Ideally, individual per-market television viewing data would be available to a processing center 107 for each household in each market. In practice, however, this is often not the case due to a combination of technical, contractual, and organizational limitations. Individual, per-market data is therefore typically available for some households 102a-f, but not for others 103a-d within a particular market. It is therefore often desirable to estimate the viewing of the households that do not report television viewing data to the processing center 107. An example process for estimating this viewing is disclosed in U.S. patent application Ser. No. 13/973,282 “SYSTEMS AND METHODS FOR PROJECTING VIEWERSHIP DATA” filed Aug. 22, 2013 (Applicant Reference, 74182-8011.US01) which is hereby incorporated in its entirety. One step in that example estimation process is to account for “network coverage”, e.g., to generate a measure of the number of reporting and non-reporting households that are subscribed to a particular network within the given market. Accordingly, using this example process, various of the disclosed embodiments in this application infer a per-market distribution of network subscriptions.

The problem of network coverage in estimating television viewing can be illustrated by the following example. Suppose that in a particular market, the reporting households are subscribed to a given network at a rate of 10% (e.g., 10% of the reporting households are subscribed to—and therefore able to view—the given network). Suppose at the same time that 20% of all the households in the particular market are subscribed to the given network. Then, if the reporting households report a rating of 1% (which is to say that at a particular time, 1% of the reporting households are viewing the given network), then it would be erroneous to conclude that the rating of the given network in the particular market is also 1%. This is because twice as many of the market's households are actually subscribed to the given network (20%) than are reflected by the reporting households (10%). Indeed, a 1% rating among the reporting households implies that 10% of the reporting households that are subscribed to the given network are watching the given network (1% rating/10% total reporting=10% of reporting households are watching). It is this “coverage rating” (10%) that should be applied to the 20% of the market households that subscribe to the given network, leading to an estimated rating of 2% rather than the measured rating of 1%. It will be understood by one skilled in the art that this example has been simplified for purposes of illustrating one of the problems addressed by the disclosed system. Various of the disclosed embodiments may compensate for these discrepancies. For example, some embodiments scale the reported household rating based upon the ratio of subscribed reporting households to the total subscribed households in a market.

### Example Data Strata

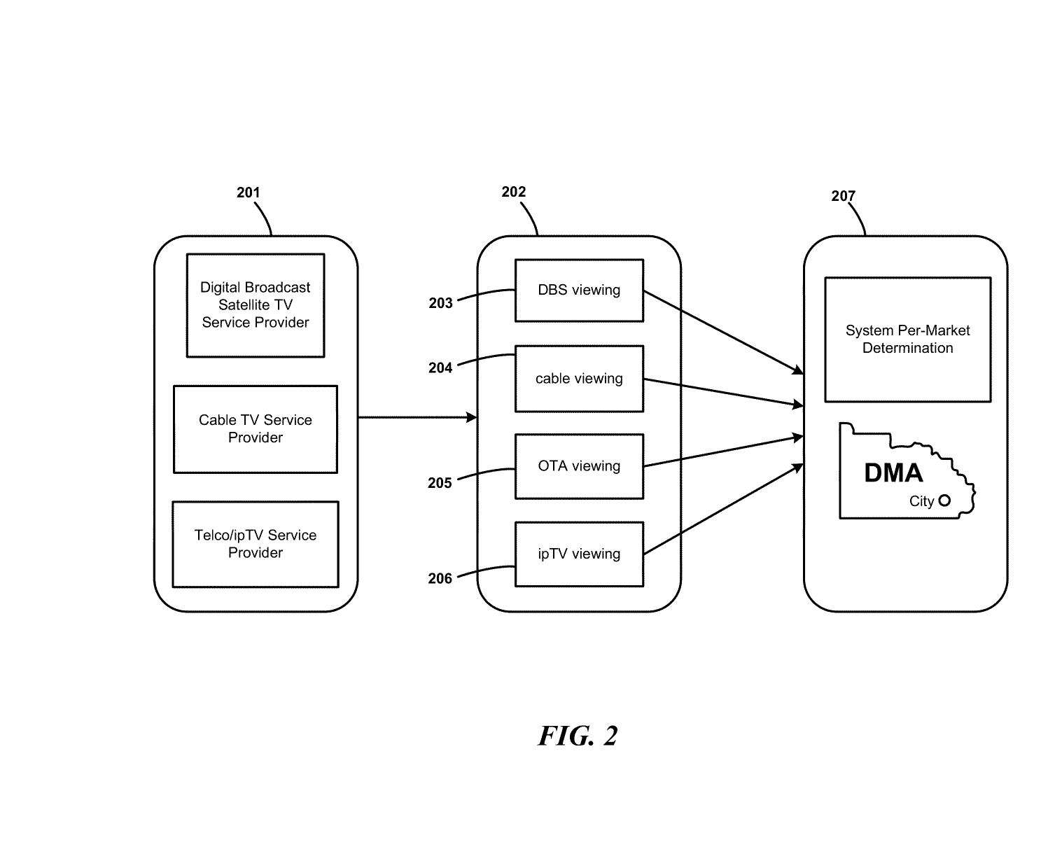

FIG. 2 illustrates a high level topology of the strata data that may be processed by the system and used to make a network viewing market allocation determination, to which network subscriber estimates may be applied. Viewing data can be collected from a variety of sources 201 by the system and organized into strata 202.

The strata 202 can include DBS viewing data 203, cable viewing data 204, OTA (over-the-air, i.e. terrestrial broadcast television) viewing data 205, IPTV viewing data 206, and other types of data reflecting the viewing behavior of an individual or audience. It will be clear to one skilled in the art that the depicted breakdown of television households into strata is merely an example. Many other alternative categorizations are possible, for example digital versus analog cable, service-provider-specific divisions, etc.

In some embodiments, the system operates on the strata 202 to generate a per-market estimate 207 of network viewership.

### Example Data Processing Architecture

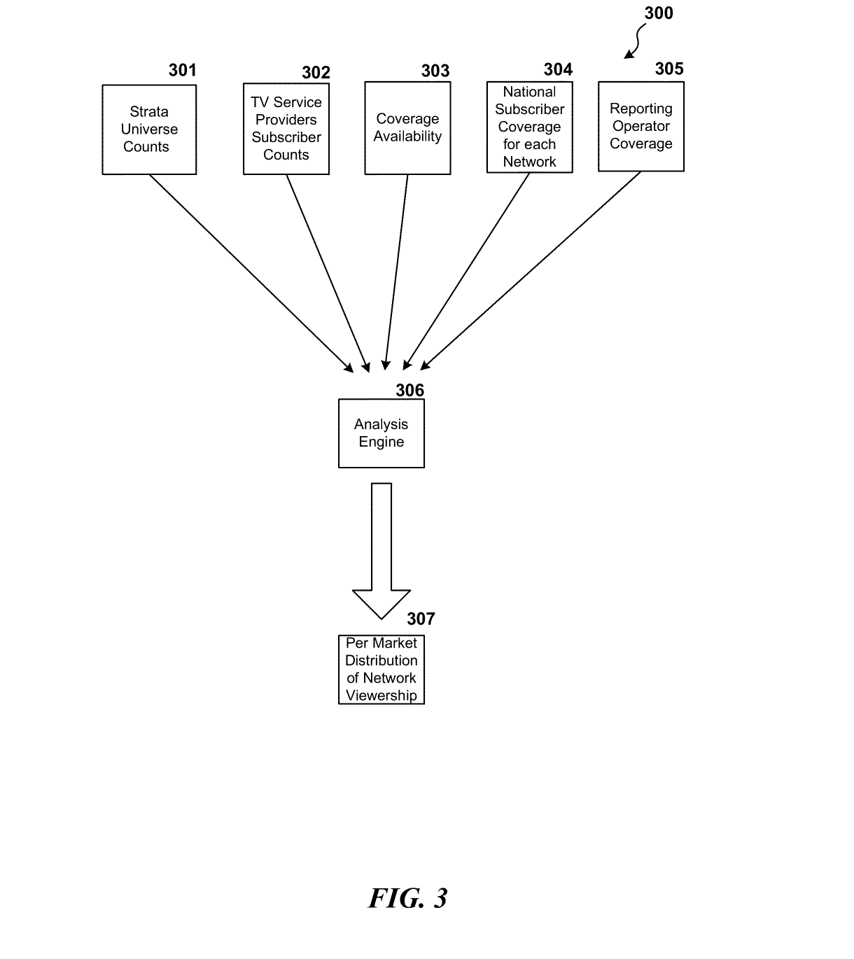

FIG. 3 illustrates a high level topology of a data processing architecture 300 used by the system to estimate a per-market distribution of network subscribers. As discussed with reference to various embodiments herein, an analysis engine 306 in the system can receive a plurality of input data 301-305 and produce a per-market distribution of network subscription viewership 307.

The input data can include a universe strata count dataset 301. The universe strata count dataset includes an estimate of the number of television households in each stratum in each television market tracked by the system.

The input data can also include a cable count dataset 302. The cable count dataset 302 may include other operators and may more generally refer to a multichannel video programming distributor. This data set can include an estimate of the number of subscribers of each television service provider in each market. For example, the dataset might contain a record for the number of Comcast® subscribers in the Seattle Wash. market, and the number of Time-Warner Cable® subscribers in the Washington D.C. market, and so forth. These subscriber counts represent the number of households that receive their television service from each service provider in each market, without regard to what networks are subscribed to or offered by the service provider.

The input data can also include a coverage availability dataset 303. The coverage availability dataset includes information about which networks are offered/available to each television service provider's subscribers, without reference to the number of subscribers that choose to subscribe to any given network. For example, this dataset might indicate that in the Portland, Oreg. market, Comcast offers ESPN® to its subscribers, but does not offer ZeeTV®. In some embodiments, the coverage availability dataset may be derived from television scheduling information, or it may be provided by the television service providers or by the networks.

The input data can also include a national subscriber coverage dataset for each network 304. The national subscriber coverage dataset contains an estimate of the total number of national subscribers there are for each network. In some embodiments, the subscriber coverage data is subdivided into HD (high definition) and SD (standard definition) versions of the network. For example, the dataset may say that ESPN® has 99,384,576 subscribers, or it may say that ESPN SD® has 95,243,453 subscribers and ESPN HD® has 22,345,123 subscribers (these numbers are for example only, and are not intended to be a meaningful representation of the true numbers of subscribers). Such estimates may be derived from a variety of sources, such as public financial disclosures, industry trade press, from the networks themselves, from proprietary data sources, etc.

The input data can also include a reporting operator coverage dataset 305 (e.g., a dataset of existing/available coverage data). That is, a network operator that provides tune-level set-top box (STB) television viewing data will often also provide support data that can include the number of network-subscribing households for each network in each market. This information can be used by the system to estimate the regional popularity of a network. For example, a Spanish-language network is likely to have higher subscriber percentages in a highly Hispanic market than in a less Hispanic market, and the reporting operator coverage data can be a way to measure these relative differences.

### Example Data Processing Architecture

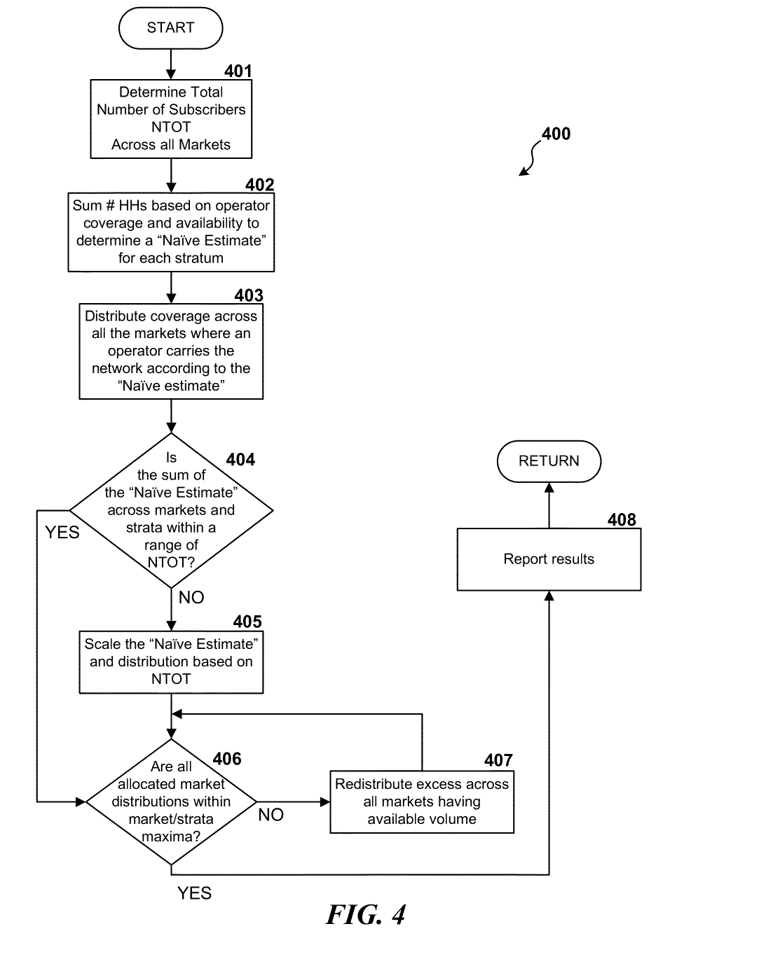

FIG. 4 is a flow diagram depicting various steps in a subscription market allocation process 400 as can be implemented by the system. The allocation process 400 is repeatedly executed by the system to generate, for each network being assessed, an estimate of subscriptions to the network across multiple markets.

At block 401 the system determines the total number of subscribers (N_{TOT}) to a particular network across all the markets being assessed (e.g., using one or more of datasets 301-305). The assessed markets may encompass a country (e.g., the United States or Germany), a region (e.g., the Midwest), a state (e.g., California), a county, or any other area. The datasets may include aggregate data from the entire market or more granular information from market subgroups.

At block 402 the system uses the operator coverage of each assessed market to generate a bottom-up estimate of network coverage. To do so, the system sums the number of subscribing households according to operator coverage in each market to determine a “naïve estimate” of the number of households that subscribe to a particular network for all assessed markets. The designation “naïve estimate” merely reflects the fact that this estimate is an initial estimate that may not yet be based on all the available or relevant data and therefore may not have a high degree of accuracy. For example, certain markets may lack subscribing household data.

At block 403 the system generates an estimate of the coverage in each geographic market within the assessed markets where at least one operator in the market carries the network. This “naïve estimate” is an initial allocation to each market from which the algorithm can later develop a more accurate prediction. Although an equal allocation may be placed in each market (for example, dividing the data equally between each market), in some embodiments the system may proactively anticipate market characteristics with a weighted distribution. For example, if preexisting knowledge suggests that one market should receive a higher allocation, the system may apportion a larger amount of the “naïve estimate” to that market.

As an example of a naïve, equally weighted distribution, consider a naïve estimate of 6,000 subscribers for six markets. In this situation, each market would initially be estimated to have 1,000 subscribers (regardless of any knowledge regarding the subscriber capacities of each market). In some embodiments, the system may divide the naïve estimate in proportion to the total number of households that subscribe to operators able to subscribe to the network, even though the operators may not actually subscribe to the network. For example, if the naïve estimate is 6,000 subscribers for two markets, and each of the networks have two operators but only three of the four operators are able to subscribe to the network, then one of the markets may be estimated to have 4,000 subscribers and the other market may be estimated to have 2,000 subscribers.

At block 404 the system determines if the naïve estimate is within a threshold of the known total number of subscribers (N_{TOT}). By doing so, the system in essence checks to see how close the estimated number of subscribers is using the bottom-up methodology to the actual number of subscribers reported by the network or otherwise representing the total number of subscribers. If the naïve estimate is close to the aggregate number of subscribers, the system accepts the naïve estimate as sufficiently accurate and processing continues to a block 406. If, however, the naïve estimate falls outside an acceptable range from the total number of subscribers, processing continues to a block 405 where the naïve estimate is adjusted.

At block 405 the system scales the “naïve estimate” based upon the total number of subscribers. For example, if the “naïve estimate” is 80% (e.g., 80 subscribers) of the known total number of subscribers (e.g., 100 subscribers), the system can increase the overall naïve estimate by 25% (that is, multiply the naïve estimate by 1.25 so that the naïve estimate approximates the total number of subscribers, i.e., 80+25%*80=100). The scaled naïve estimate is allocated to each market in accordance with the allocation method described in block 403. Alternatively, the system may merely directly calculate a scaled naïve estimate that is already associated with each market.

At block 406 the system determines, for each market, if the scaled naïve estimate for that market is still within the maximum capacity of the market. For example, a market may only support 450 subscribers. If the current scaled naïve estimate for that market places more than 450 subscribers in that market, then the system determines that the allocations require redistribution and processing continues to block 407. Otherwise, the system concludes that the scaled naïve estimates are sufficiently accurate to use as a basis for further processing.

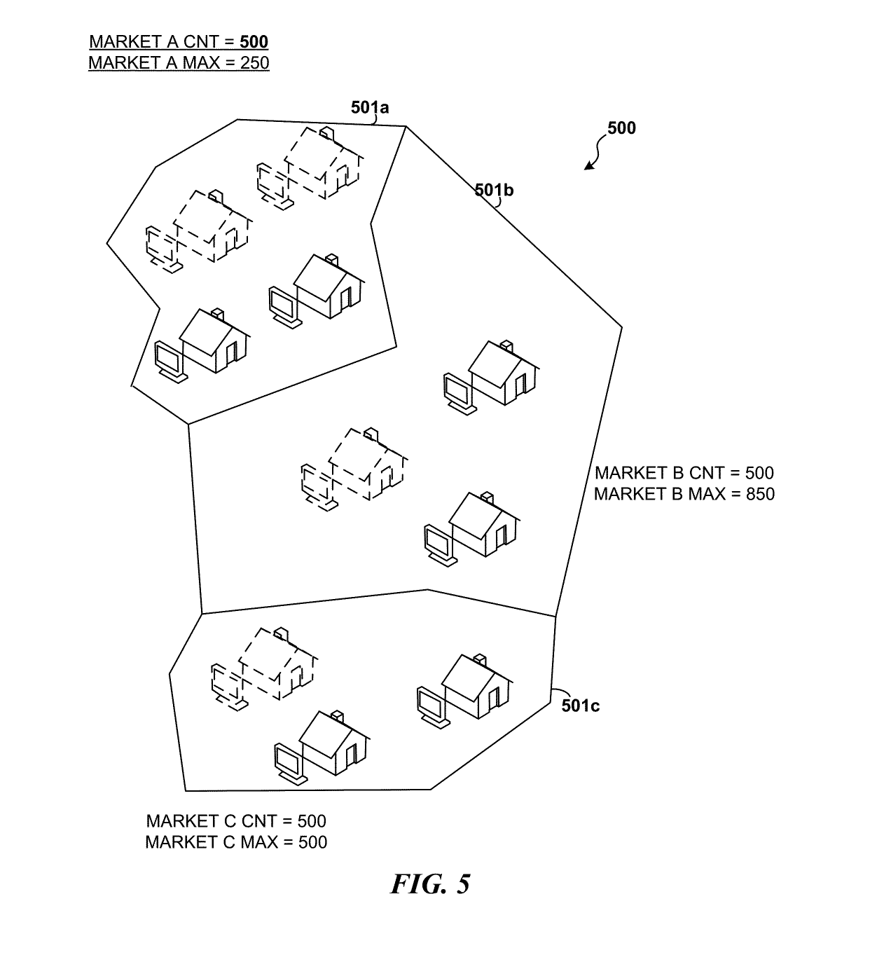

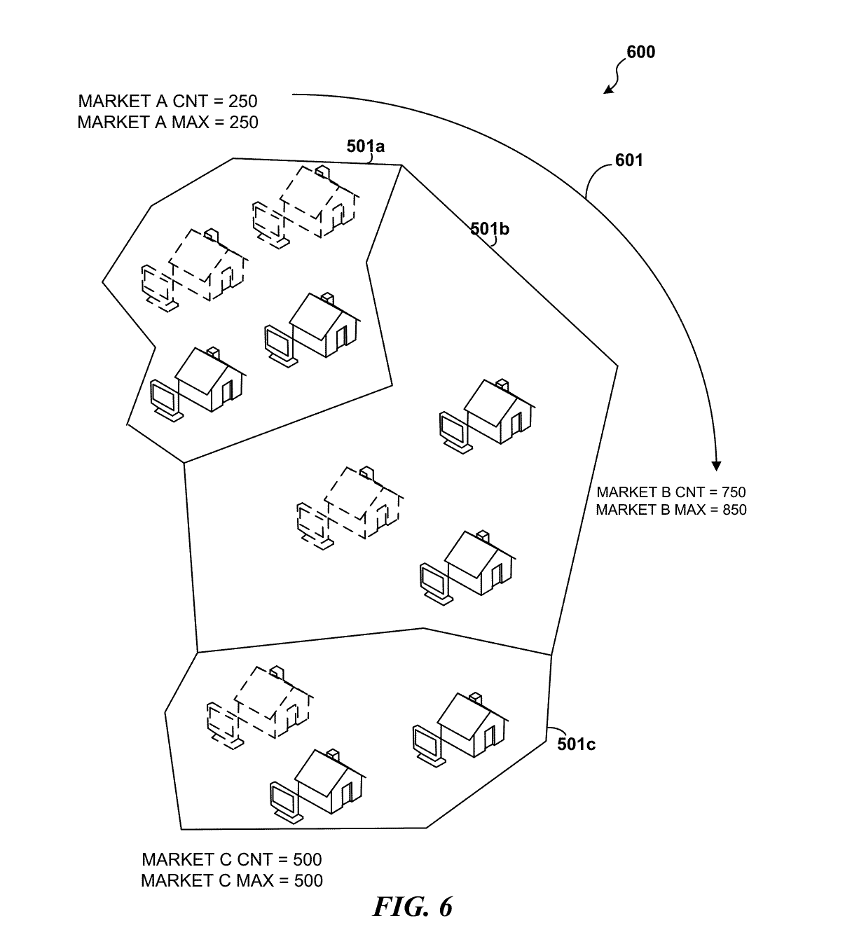

If redistribution from a market is required, at block 407 the system redistributes the excess subscribers across all the markets. A representative redistribution methodology is described in greater detail below with reference to FIGS. 5 and 6. The system may distribute a number of subscribers from a particular market to others so that the estimate for that particular market is equal to the number of subscribers in that market (e.g., to 450 subscribers using the example above). Alternatively or additionally, the system may distribute a greater number of subscribers so that the estimate for that particular market is equal to a selected percentage of the number of subscribers in that market (e.g., the system may assume there is no greater than 98% penetration in any particular market to generally account for practical limitations in measuring or accounting for subscribers).

At block 408 the system reports, records, or otherwise finalizes the market allocation results for the subscription network. The market allocation results may be used by content producers, distributors, advertisers, and other interested parties to make decisions about content and advertising. For example, particular markets may be targeted by an advertiser.

### Example Data Processing Architecture

FIG. 5 illustrates a market allocation 500 of subscription counts following a first iteration of allocations of a naïve estimate (after scaling, if any) by the system. In the naïve estimate allocation, the current naïve estimate of 1,500 has been evenly distributed across each of the markets 501a-c so that 500 subscribers are assigned to each market. While 500 subscribers is within the capacity of markets 501b (max capacity 850) and 501c (max capacity 500), it is not within the capacity of market 501a (max capacity 250). Accordingly, at block 406 described above, the system can determine that further reallocation is necessary and reassign a number of the subscribers from market 501a to other markets.

FIG. 6 illustrates a per-market allocation 600 of subscription counts following a second iteration of allocations of the naïve estimate by the system. Continuing from the example of FIG. 5, the system can recognize that market 501c has reached capacity and will accordingly distribute the excess of market 501a in only those other markets having excess capacity. In this example, market 501b has excess capacity and so the subscription counts are reallocated 601 by the system from market 501a to 501b.

### Example Detailed Application of Analysis Engine Inputs

As discussed, cable operators may not disclose the subscription packages of their subscribers. Accordingly, media measurement corporations may be unable to calculate the household coverage of each network. Accordingly, various of the disclosed embodiments use viewing data to infer network coverage. Often, more viewing data is likely to result in more accurate calculations of household coverage of each network because measurements of viewing data by network per household is essentially a sample (possibly complete) of the networks that could possibly be viewed by that household.

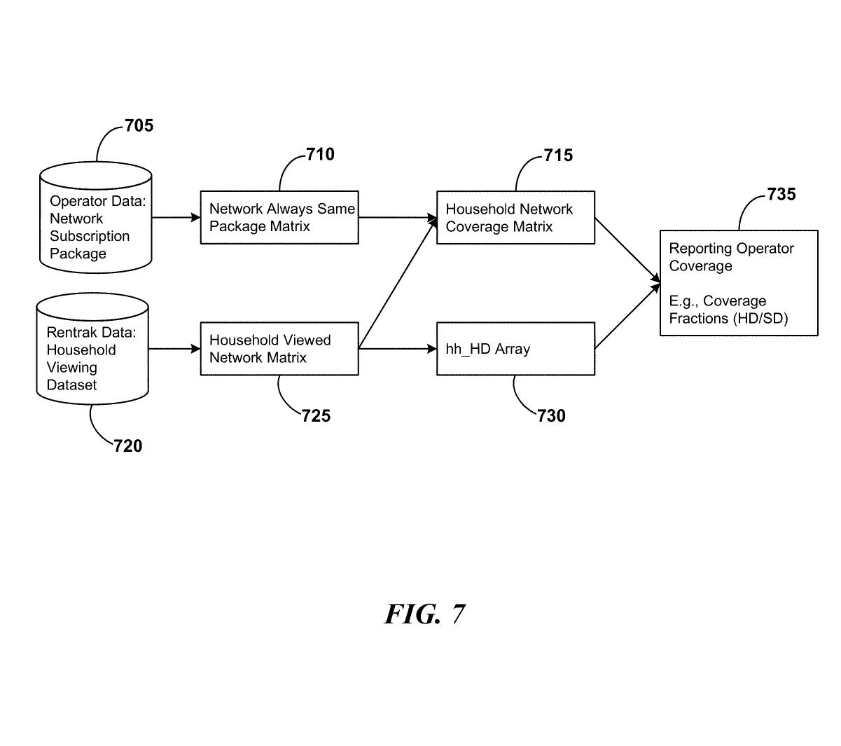

FIG. 7 is a high level block diagram illustrating steps in an example subscription calculation as may be performed in some embodiments. Particularly, this example traverses the process by which a reporting operator coverage dataset 305 may be determined. In this example, a central computer system may use operator data for a network subscription package 705 to create a “Network Always the Same” (NAS) data matrix 710. The system may also use household viewing data taken from a monitoring service (e.g., Rentrak®) to generate a “Household Viewed Network” (HVN) data matrix 725. The system may use the HVN to generate an hh_HD array 730 as well as to generate a “Household Network Coverage” (HNC) data matrix 715 in conjunction with the NAS data matrix 710. The HNC data matrix 715 and the HH_HD array 730 may then be used to generate a representation of the reporting operator coverage 735. The reporting operator coverage 735 may then be used by the analysis engine 306 as the naïve estimate for block 402 (the total number of subscribers at block 401 being provided, e.g. in the count dataset 302). For example, the reporting operator coverage 735 may correspond to the reporting operator coverage dataset 305.

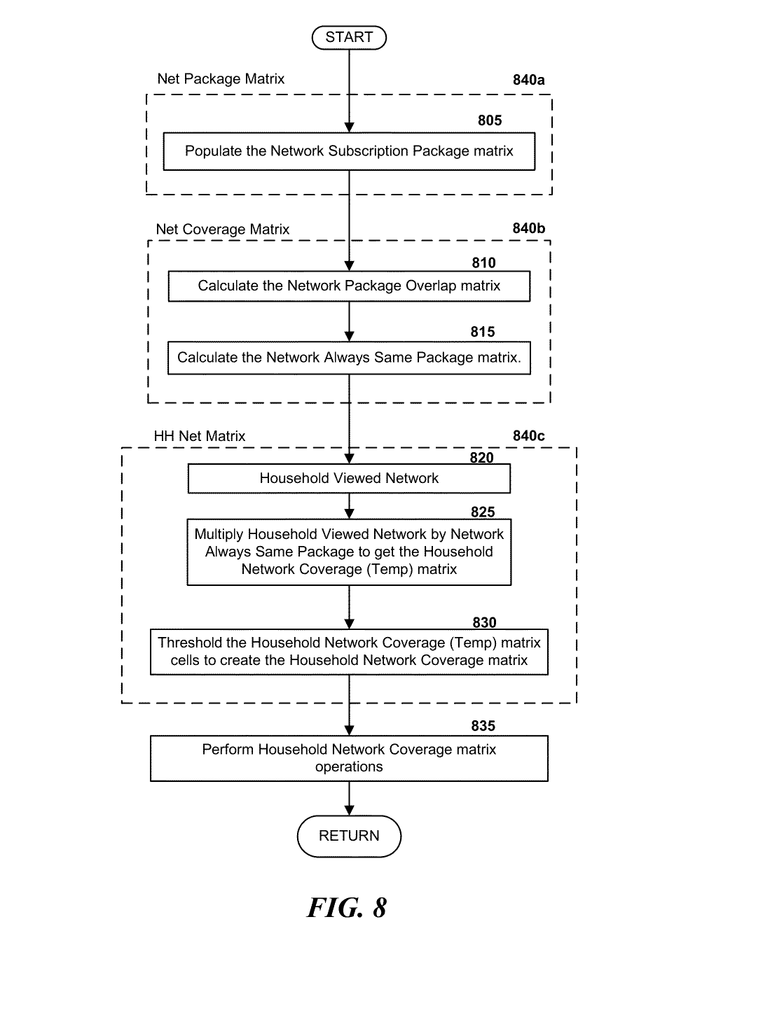

FIG. 8 is a flow diagram illustrating aspects of the example subscription calculation of FIG. 7 in greater detail. To facilitate an understanding of these processes, each step will be discussed in the context of a specific (arbitrary) example. The following example considers a single market having: one operator; eight networks offered by the one operator; and three subscription packages. Naturally, this example is merely intended to facilitate understanding while actual situations will be much more complex (e.g., having more operators, more subscription packages, etc.).

### Net Package Matrix

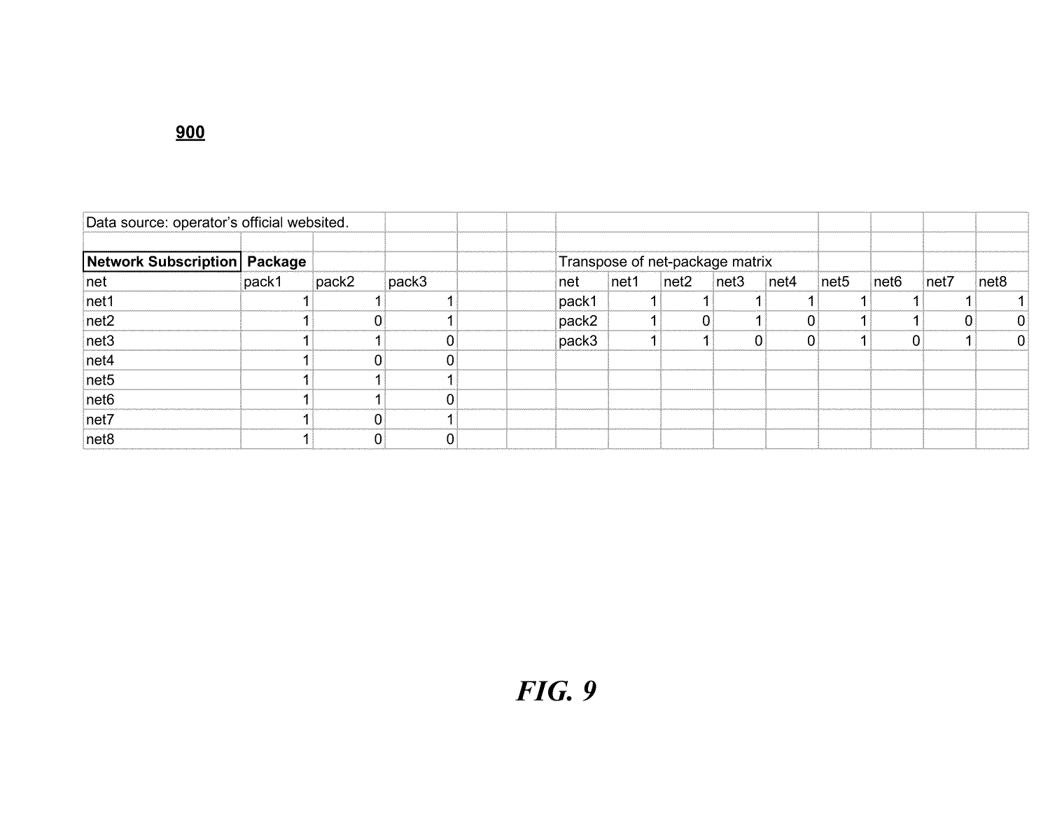

At block 840a the system may populate an NAS matrix (roughly corresponding to block 710). FIG. 9 is an example Network Subscription Package data matrix as may be implemented in some embodiments in accordance with this example. A Network Subscription Package data matrix indicates a correspondence between a network and a package's availability on that network. In this example, there are three packages and eight networks. The Network Subscription Package matrix 900 may, e.g., be populated from the coverage available step in block 303 of FIG. 3.

### Net Covariance Matrix

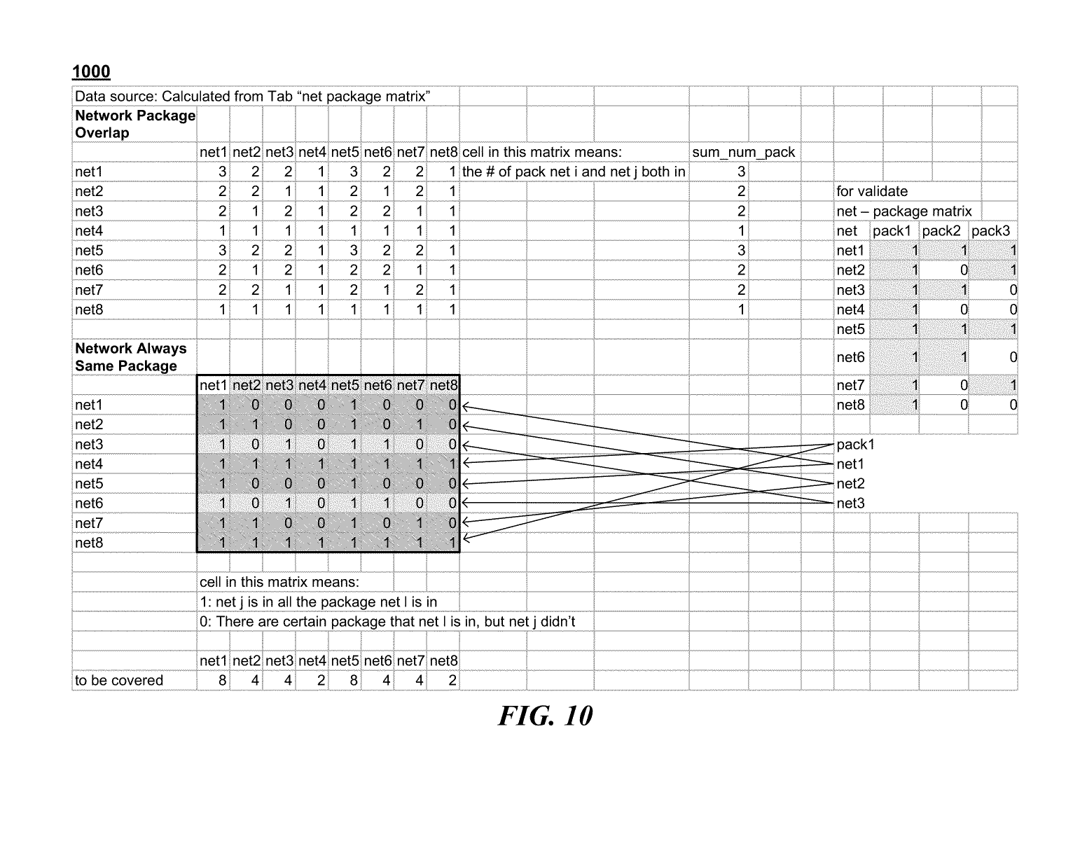

At block 840b the system may determine one or more network coverage matrices (e.g., this step may roughly corresponding to block 715). FIG. 10 is a collection of example network coverage data matrices as may be implemented in some embodiments, including a Network Package Overlap matrix and a Network Always the Same Package matrix. A Network Always the Same Package matrix indicates which networks have the same or greater package coverage than their peers. A Network Package Overlap matrix indicates a number of packages shared between two networks. Block 840b may itself comprise two steps, the calculation of the Network Package Overlap matrix at block 810 and the calculation of the “Network Always Same Package” matrix at block 815. At block 810, each cell M(i,j) in the Network Package Overlap matrix contains the number of subscription packages containing both network(i) and network(j). At block 815, each cell M(i,j) in the Network Always Same Package matrix is 1 if network(j) is in all the subscription packages that network(i) is in, and 0 otherwise. Stated another way, each network row i captures the other networks that are in the same subscription package as network i.

### HH_NET Matrix

At block 840c the system may determine the Household Net Matrix, which may itself comprise the septs of determining the Household Viewed Network matrix at block 820, multiplying the Household Viewed Network matrix by the Network Always Same Package matrix to create the Household Network Coverage (temporary) Matrix at block 825, and then threshold the Household Network Coverage (temporary) Matrix at block 830 to create the Household Network Coverage Matrix. At block 825, Multiply Household Viewed Network (in the example, 11×8 matrix) by Network Always Same Package (in the example, 8×8 matrix) to get the Household Network Coverage (Temp) matrix. Household Viewed Network: Each cell M(i,j) is 1 if household hh(i) has ever watched network(j) during the defined viewing period where data is available.

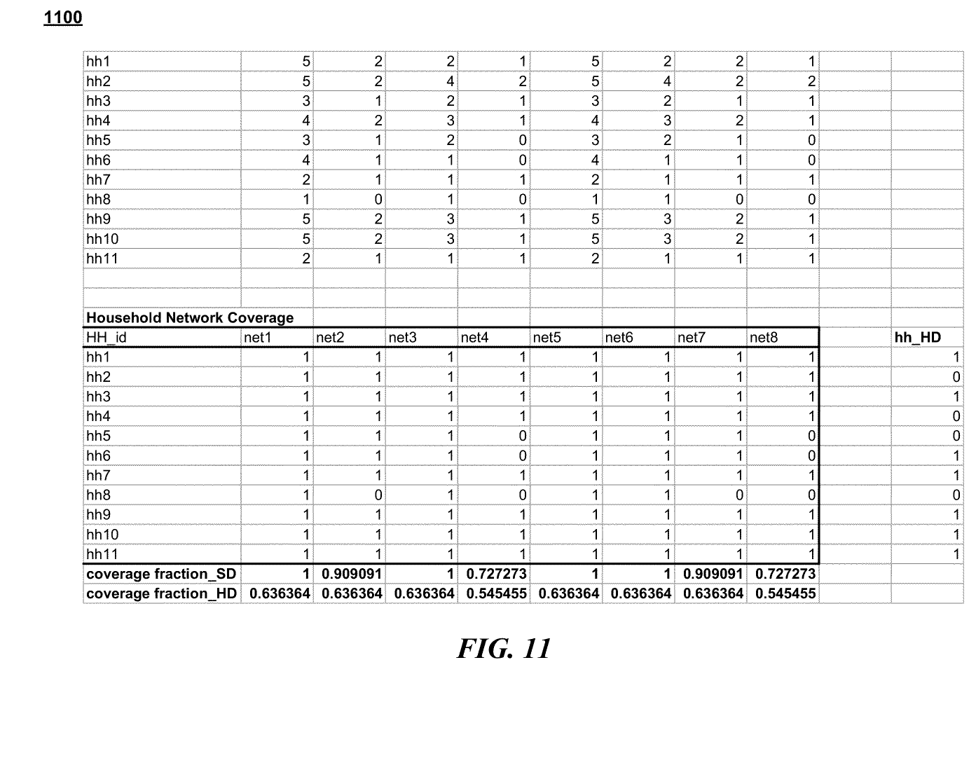

At block 830, in Household Network Coverage (Temp) net temp, for all cells M(i,j), if M(i,j)>=1, set M(i,j) to 1. Otherwise, keep M(i,j) as 0. The resulting matrix is referred to as the Household Network Coverage matrix. FIG. 11 is an example household network data matrix as may be implemented in some embodiments. A Household Network Coverage Matrix indicates a relation between a household identifier and the corresponding household's ability to view a given network. In Household Network Coverage, M(i,j)=1 means that household hh(i) can definitely watch network(j) (based on its subscription package). M(i,j)=0 means that hh(i) may not be able to watch network(j).

The Household Network Coverage Matrix may then be suitable for coverage assessment operations and analysis at block 835. For example, the coverage fraction for a network may be used as the “naïve estimate” coverage at block 402.

### HH_NET Matrix—Calculation Detail

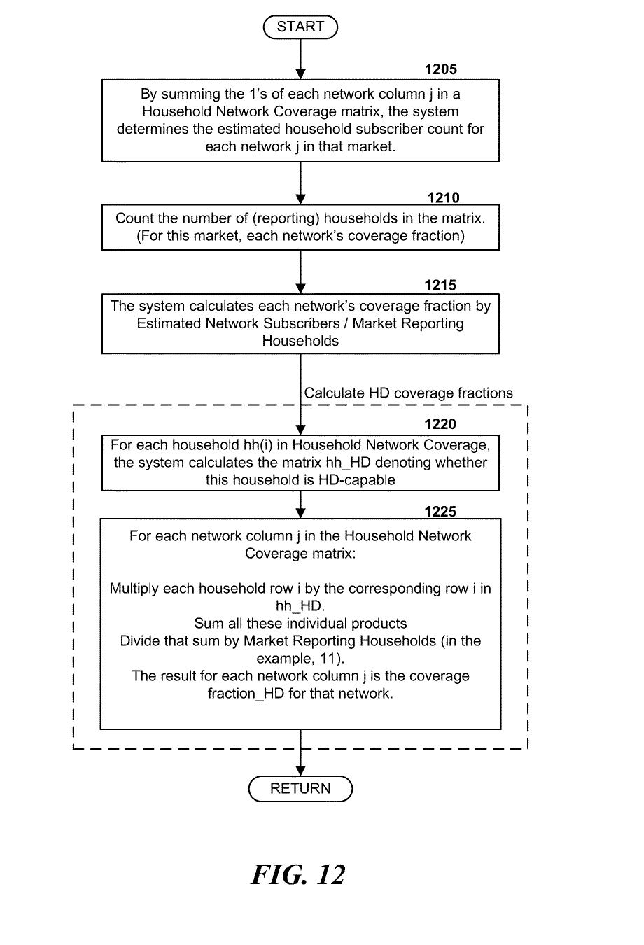

FIG. 12 is a flow diagram depicting operations applied to a household matrix as may occur in some embodiments. At block 1205, the system may determine the estimated household subscriber count for each network j in the corresponding market by summing the 1's of each network column j in the Household Network Coverage matrix. The result is referred to as the “Estimated Network Subscribers”.

At block 1210, the system may count the number of (reporting) households in the matrix. This reflects each network's coverage fraction for this market. The result is referred to as the “Market Reporting Households”.

At block 1215, the system may then calculate each network's coverage fraction by dividing the Estimated Network Subscribers by the Market Reporting Households. In the example, the result is referred to as coverage fraction_SD.

HD coverage fractions may be calculated in accordance with blocks 1220 and 1225. At block 1220, for each household hh(i) in Household Network Coverage, the system may calculate the matrix hh_HD denoting whether the household is HD-capable. At block 1225, the system may iterate over each network column j in the Household Network Coverage matrix.

For each column the system may multiply each household row i by the corresponding row i in hh_HD. The results of all these individual products may then be summed and divided by Market Reporting Households (in this example, 11). The result for each network column j is then the coverage fraction_HD for that network.

The Household Network Coverage matrix, and all the resulting coverage fraction calculations, may be calculated for each market. Consequently the system may perform the above calculations for hundreds of these matrices.

### Result Presentation

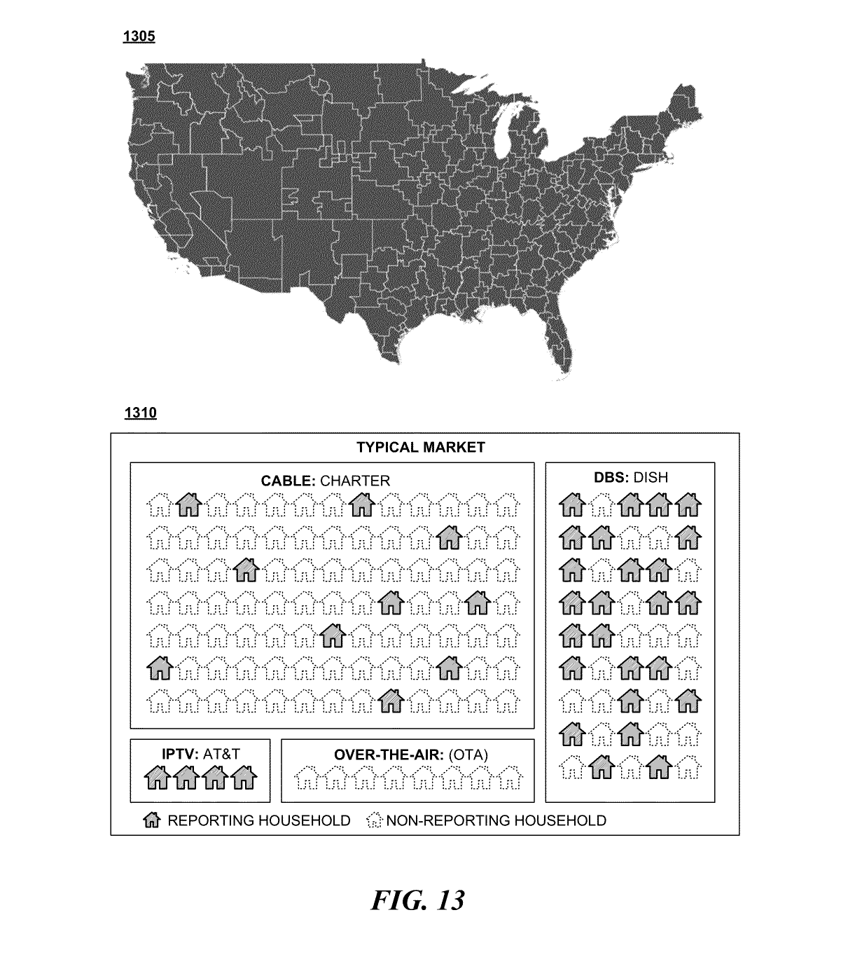

FIG. 13 is an example hypothetical market household breakdown as may be presented in some embodiments. For example, a plurality of geographic markets 1305 may be presented to a user in a GUI. By selecting a market, the user may then view the market breakdown 1310. Such a breakdown may be provided, e.g., at block 408.

### Computer System

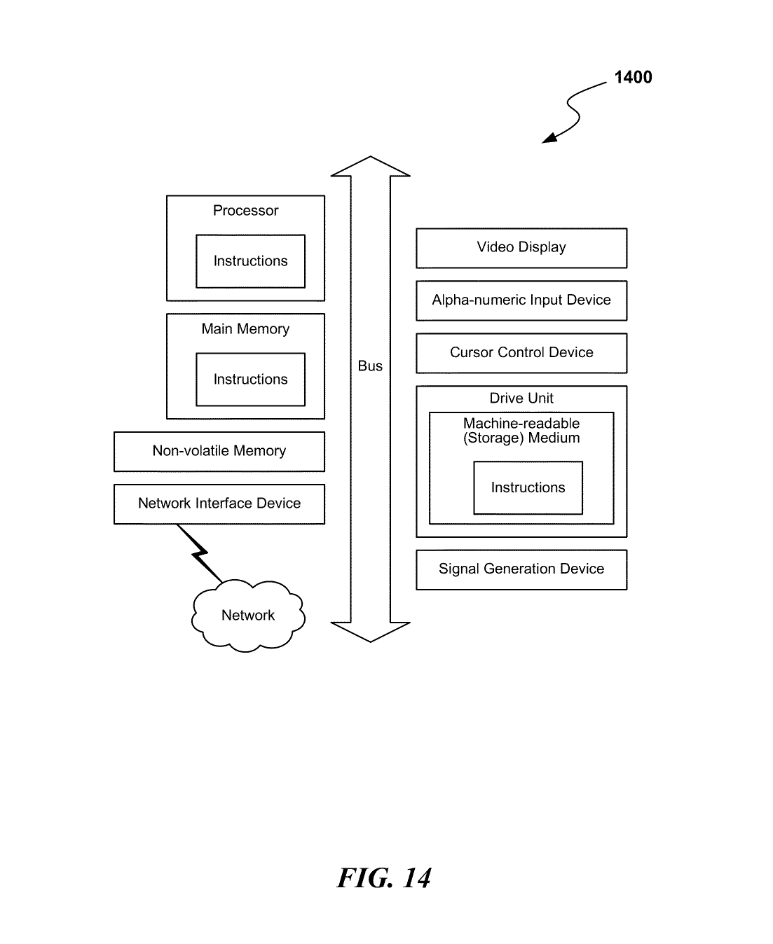

FIG. 14 shows a diagrammatic representation of a machine 1400 in the example form of a computer system within which a set of instructions, for causing the machine to perform any one or more of the methodologies discussed herein, can be executed.

In alternative embodiments, the machine operates as a standalone device or can be connected (e.g., networked) to other machines. In a networked deployment, the machine can operate in the capacity of a server or a client machine in a client-server network environment, or as a peer machine in a peer-to-peer (or distributed) network environment.

The machine can be a server computer, a client computer, a personal computer (PC), a user device, a tablet PC, a laptop computer, a set-top box (STB), or any machine capable of executing a set of instructions (sequential or otherwise) that specify actions to be taken by that machine.

While the non-transitory machine-readable medium or non-transitory machine-readable storage medium is shown in an exemplary embodiment to be a single medium, the term “non-transitory machine-readable medium” and “non-transitory machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation. The term “non-transitory” should be taken to include all computer-readable media, with the sole exception being a transitory, propagating signal.

In general, the routines executed to implement the embodiments of the disclosure, can be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of non-transitory machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The network interface device enables the machine to mediate data in a network with an entity that is external to the host server, through any known and/or convenient communications protocol supported by the host and the external entity. The network interface device can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network interface device can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall can additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

### Remarks

The description and drawings are illustrative and are not to be construed as limiting. Numerous specific details are described to provide a thorough understanding of the disclosure. However, in certain instances, well-known details are not described in order to avoid obscuring the description. References to one or an embodiment in the present disclosure can be, but not necessarily are, references to the same embodiment; and, such references mean at least one of the embodiments.

Those skilled in the art will appreciate that the logic and process steps illustrated in the various flow diagrams discussed herein can be altered in a variety of ways. For example, the order of the logic can be rearranged, substeps can be performed in parallel, illustrated logic can be omitted, other logic can be included, etc. One will recognize that certain steps can be consolidated into a single step and that actions represented by a single step can be alternatively represented as a collection of substeps. The figures are designed to make the disclosed concepts more comprehensible to a human reader. Those skilled in the art will appreciate that actual data structures used to store this information can differ from the figures and/or tables shown, in that they, for example, can be organized in a different manner; can contain more or less information than shown; can be compressed and/or encrypted; etc.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others. Similarly, various requirements are described which can be requirements for some embodiments but not other embodiments.

The embodiments provided herein can be applied to other systems, not necessarily the system described above. The elements and acts of the various embodiments described above can be combined to provide further embodiments. Accordingly, the actual scope of the invention encompasses not only the disclosed embodiments, but also all equivalent ways of practicing or implementing the invention under the claims.

What is claimed is:

1. A computer-implemented method of estimating the coverage by market by operator for a content network, comprising:
determining a total number of subscribers to a content network across a plurality of markets;
determining an estimated total number of subscribers to the content network based on existing coverage data across the plurality of markets;
distributing the estimated total number of subscribers evenly across each of the plurality of markets;
scaling at least one distribution in a market based on a comparison of the estimated total number of subscribers and the total number of subscribers; and
reallocating subscriptions between at least two markets in the plurality of markets based upon the capacities of the at least two markets.

2. The computer-implemented method of claim 1, wherein determining a total number of subscribers to a content network across a plurality of markets comprises receiving a network subscription package.

3. The computer-implemented method of claim 1, wherein determining an estimated total number of subscribers to the content network comprises:
generating a Network Package Matrix;
generating at least one Network Coverage Matrix; and
generating a Household Network Matrix.

4. The computer-implemented method of claim 3, wherein generating at least one Network Coverage Matrix comprises:
calculating a Network Package Overlap matrix; and
calculating a Network Always Same Package matrix.

5. The computer-implemented method of claim 3, wherein generating a Household Network Matrix comprises:
generating a Household Viewed Network matrix; and
multiplying the Household Viewed Network matrix by the Network Always Same Package matrix to generate the Household Network Coverage matrix; and
thresholding the Household Network Coverage matrix to create the Household Network Matrix.

6. The computer-implemented method of claim 5, wherein generating a Household Network Matrix comprises determining a fraction of the plurality of markets associated with High Definition devices.

7. The computer-implemented method of claim 1, further comprising:
presenting a graphical user interface depicting a plurality of geographic markets;
receiving a selection of a market from a user; and
presenting a visualization of the reporting and non-reporting households associated with the market.

8. A computer system comprising:
at least one computer processor;
at least one memory comprising instructions configured to cause the at least one computer processor to perform a method comprising:
determining a total number of subscribers to a content network across a plurality of markets;
determining an estimated total number of subscribers to the content network based on existing coverage data across the plurality of markets;
distributing the estimated total number of subscribers evenly across each of the plurality of markets;
scaling at least one distribution in a market based on a comparison of the estimated total number of subscribers and the total number of subscribers; and
reallocating subscriptions between at least two markets in the plurality of markets based upon the capacities of the at least two markets.

9. The computer system of claim 8, wherein determining a total number of subscribers to a content network across a plurality of markets comprises receiving a network subscription package.

10. The computer system of claim 8, wherein determining an estimated total number of subscribers to the content network comprises:
generating a Network Package Matrix;
generating at least one Network Coverage Matrix; and
generating a Household Network Matrix.

11. The computer system of claim 8, wherein generating at least one Network Coverage Matrix comprises:
calculating a Network Package Overlap matrix; and
calculating a Network Always Same Package matrix.

12. The computer system of claim 11, wherein generating a Household Network Matrix comprises:
generating a Household Viewed Network matrix; and
multiplying the Household Viewed Network matrix by the Network Always Same Package matrix to generate the Household Network Coverage matrix; and
thresholding the Household Network Coverage matrix to create the Household Network Matrix.

13. The computer system of claim 12, wherein generating a Household Network Matrix comprises determining a fraction of the plurality of markets associated with High Definition devices.

14. The computer system of claim 8, the method further comprising:
presenting a graphical user interface depicting a plurality of geographic markets;
receiving a selection of a market from a user; and
presenting a visualization of the reporting and non-reporting households associated with the market.

15. A non-transitory computer-readable medium comprising instructions configured to cause at least one computer processor to perform a method comprising:
determining a total number of subscribers to a content network across a plurality of markets;
determining an estimated total number of subscribers to the content network based on existing coverage data across the plurality of markets;
distributing the estimated total number of subscribers evenly across each of the plurality of markets;
scaling at least one distribution in a market based on a comparison of the estimated total number of subscribers and the total number of subscribers; and
reallocating subscriptions between at least two markets in the plurality of markets based upon the capacities of the at least two markets.

16. The non-transitory computer-readable medium of claim 15, wherein determining a total number of subscribers to a content network across a plurality of markets comprises receiving a network subscription package.

17. The non-transitory computer-readable medium of claim 15, wherein determining an estimated total number of subscribers to the content network comprises:
generating a Network Package Matrix;
generating at least one Network Coverage Matrix; and
generating a Household Network Matrix.

18. The non-transitory computer-readable medium of claim 17, wherein generating at least one Network Coverage Matrix comprises:
calculating a Network Package Overlap matrix; and
calculating a Network Always Same Package matrix.

19. The non-transitory computer-readable medium of claim 17, wherein generating a Household Network Matrix comprises:
generating a Household Viewed Network matrix; and
multiplying the Household Viewed Network matrix by the Network Always Same Package matrix to generate the Household Network Coverage matrix; and
thresholding the Household Network Coverage matrix to create the Household Network Matrix.

20. The non-transitory computer-readable medium of claim 19, wherein generating a Household Network Matrix comprises determining a fraction of the plurality of markets associated with High Definition devices.

21. The non-transitory computer-readable medium of claim 15, the method further comprising:
presenting a graphical user interface depicting a plurality of geographic markets;
receiving a selection of a market from a user; and
presenting a visualization of the reporting and non-reporting households associated with the market.
